(19) United States
(12) Patent Application Publication
(10) Pub. No.: US 2025/0180756 A1
(43) Pub. Date: Jun. 5, 2025

(54) TWO-PART ABSORBER FOR X-RAY CALORIMETER

(71) Applicant: Analex Corporation, Chantilly, VA (US)

(72) Inventors: George Williams, Colorado Springs, CO (US); Todd Evan Vande Brake, Peyton, CO (US); Gary Lee Paderewski, Colorado Springs, CO (US)

(21) Appl. No.: 18/524,632

(22) Filed: Nov. 30, 2023

(51) Int. Cl. G01T 1/00; G01K 17/00; G01T 7/00; G21K 1/10

(52) U.S. Cl. CPC G01T 1/006; G01K 17/00; G01T 7/00; G21K 1/10

(57) ABSTRACT

An absorber for electromagnetic calorimeters that comprises a front portion and a rear portion that are made of different materials. The front portion may comprise a first material that is resistant to blow off (which can result in spalling) and vaporization from electromagnetic radiation (e.g., X-rays) exposure. The rear portion may comprise a second material that has a higher atomic number than the first material. For example, the example, the front portion may comprise graphite and the rear portion may comprise aluminum. The front portion may comprise 1 millimeter (mm) (0.039 inches (in)) thick AXM-5Q graphite, and the rear portion may comprise 1 mm (0.039 in) thick 6061-T6 aluminum. Thus, the absorber may fit into existing calorimeter housings and absorb high energy electromagnetic radiation at a sufficient rate, without undesirable levels of blow off or vaporization.

### STATEMENT OF GOVERNMENTAL INTEREST

This invention was made with Government support under Contract No. N00030-20-C-0014 awarded by the United States Navy/Strategic Systems Programs. The U.S. Government has certain rights in the invention.

### TECHNICAL FIELD

The present disclosure relates generally to measurement devices and, in particular, as an X-ray calorimeter for measuring X-ray energy, and a method of using the X-ray calorimeter.

### BACKGROUND

X-ray calorimeters derive the energy deposited from an X-ray radiation source by converting X-ray energy into heat. For example, such an X-ray calorimeter may be mounted to a test snout in a test chamber during testing at the National Ignition Facility (NIF) at Lawrence Livermore National Labs.

An absorber of an X-ray calorimeter may receive X-rays and convert such to heat (e.g., as a result of X-rays colliding with atoms of the absorber), and a thermocouple that is attached to the absorber and measures a temperature of the absorber as it converts X-rays to heat.

While some absorbers are able to stop and absorb 99% or more of X-rays with energies up to 5 kiloelectron volts (KeV), some X-ray sources at NIF produce a broad spectrum of X-ray energies, above 5 KeV. For example, some X-ray sources, such as copper, produce X-rays with energies from 8 KeV to 9 keV, energy levels at which standard absorbers do not provide sufficient attenuation to stop such X-rays. Thus, calorimeters with such standard absorbers may not reliably measure X-ray energy from X-ray sources with energies above 5 Kev (e.g., above 8 Kev) within the limited space of a calorimeter housing of such calorimeters.

Moreover, while a thickness of prior known absorbers can be increased to increase their energy operating range, such thicker absorbers would take longer to thermally equilibrate. Thus, using a piece of graphite that is thick enough to stop 99% or more of such high energy X-rays may not thermally equilibrate in time to acquire an accurate temperature measurement of the thicker absorber before the thermal energy begins bleeding off (e.g., into the calorimeter housing).

Additionally, such thicker absorbers may be too large to replace existing absorbers without modifying other components, such as the calorimeter housings, of existing calorimeters. Moreover, such modifications to the housings or other components of existing calorimeters may require modifications to test setup components (e.g., the test snout) to accommodate the modified calorimeters.

Existing absorbers are often made of graphite. While absorbers made of materials with a greater atomic weight than graphite can sufficiently stop such high energy X-rays without exceeding the thickness of existing graphite absorbers, such materials (e.g., aluminum) may undesirably spall or vaporize at unacceptable rates.

Accordingly, a process and device are needed to increase or raise the operating range of calorimeters, for example, in an X-ray test environment. Moreover, it would be advantageous for a new absorber to replace existing absorbers, without unsatisfactorily spalling or vaporizing, or requiring further modifications to existing calorimeters or existing test setups.

### SUMMARY

The present application provides for an absorber for electromagnetic calorimeters that comprises a front portion and a rear portion that are made of different materials. The front portion may comprise a first material that is resistant to blow off (which can result in spalling) and vaporization from electromagnetic radiation (e.g., X-rays) exposure. The rear portion may comprise a second material that has a higher atomic number than the first material. For example, the example, the front portion may comprise graphite and the rear portion may comprise aluminum. The front portion may comprise 1 millimeter (mm) (0.039 inches (in)) thick AXM-5Q graphite, and the rear portion may comprise 1 mm (0.039 in) thick 6061-T6 aluminum. Thus, the absorber may fit into existing calorimeter housings and absorb high energy electromagnetic radiation at a sufficient rate, without undesirable levels of blow off or vaporization.

Thus, the two-part absorber of the present application may provide for a higher atomic number than those previously used, for example those made entirely of graphite, may provide sufficient absorption for the higher energy X-rays (e.g., above 5 KeV, or above 8 Kev).

The two-part absorber may be utilized in place of the absorber disclosed in the application entitled “X-RAY CALORIMETER” and filed on Oct. 3, 2023 under U.S. application Ser. No. 18/480,087, the entirety of which is hereby incorporated by reference.

According to an embodiment of the present disclosure, a calorimeter may include a housing. The calorimeter may include an aperture body disposed within the housing and defining an aperture configured to allow electromagnetic radiation to move pass through a first end of the aperture body and out a second end of the aperture body along a first direction. The calorimeter may include an absorber disposed within the housing and configured to receive the electromagnetic radiation. The absorber may include a front portion formed of a first material that is configured to receive the electromagnetic radiation. The absorber may include a rear portion formed of a second material that is further from the aperture body than the front portion along the first direction, and wherein the second material is different from the first material. The calorimeter may include a thermal sensor thermally coupled to the absorber, such that the thermal sensor is configured to detect a change in temperature of the absorber.

According to another embodiment of the present disclosure, an electromagnetic calorimeter absorber may include a front portion that comprises a first material. The electromagnetic calorimeter absorber may include a rear portion that comprises a second material. The first material may be more resistant to blow off or vaporization from electromagnetic radiation than the second material. The second material has a higher atomic number than the first material.

Any of the features of the above and below disclosed embodiments of the electromagnetic calorimeter absorber and/or the calorimeter may be used in combination with one another.

### BRIEF DESCRIPTION OF THE DRAWINGS

The foregoing summary, as well as the following detailed description of illustrative embodiments of the calorimeter of the present application, will be better understood when read in conjunction with the appended drawings. For the purposes of illustrating the apparatus of the present application, there is shown in the drawings illustrative embodiments. It should be understood, however, that the application is not limited to the precise arrangements and instrumentalities shown. In the drawings:

FIG. 1A is an oblique top view of a test mount assembly.

FIG. 1B is an oblique top view of the test mount of FIG. 1 with its top removed so that multiple electromagnetic calorimeters held by a mount of the test mount assembly are visible.

FIG. 2 is an oblique view of one of the electromagnetic calorimeters of FIG. 1B.

FIG. 3A is a side cross-sectional view of the electromagnetic calorimeter of FIG. 2, including cloth thermal insulators that abut an absorber.

FIG. 3B is a side cross-sectional view of the absorber of FIG. 3A, which includes a front portion that includes a first material and a rear portion that includes a second material.

FIG. 3C is a side cross-sectional view of cable clamps of the electromagnetic calorimeter of FIG. 3A.

FIG. 4 is a side view of the electromagnetic calorimeter of FIG. 2 along with a connector and flexible cable tube.

FIG. 5 is an oblique exploded view of the electromagnetic calorimeter of FIG. 2.

FIG. 6 is a plot representing temperatures detected by a thermal sensor of the electromagnetic calorimeter of FIG. 2 versus time.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the scope of the present disclosure. Also, as used in the specification including the appended claims, the singular forms “a,” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

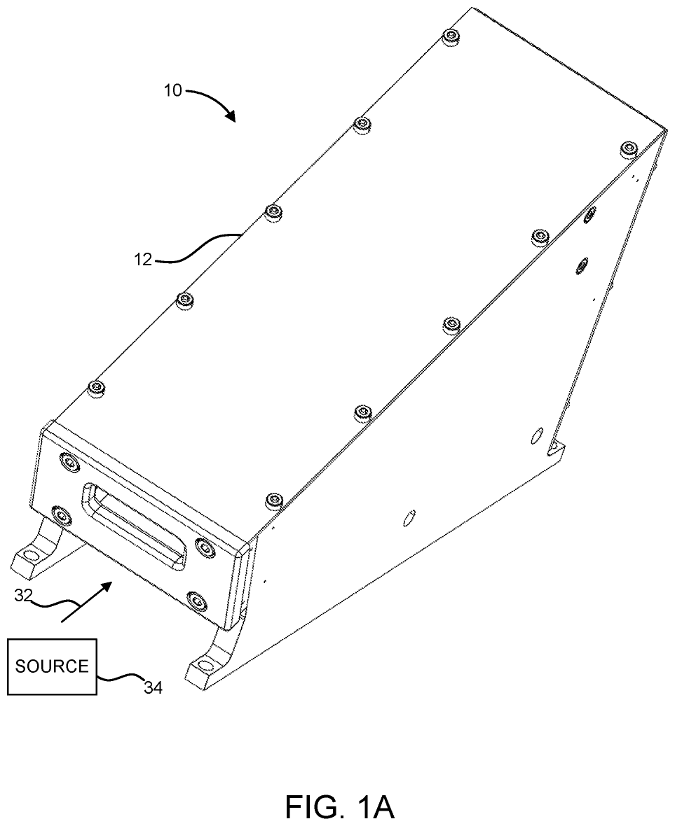

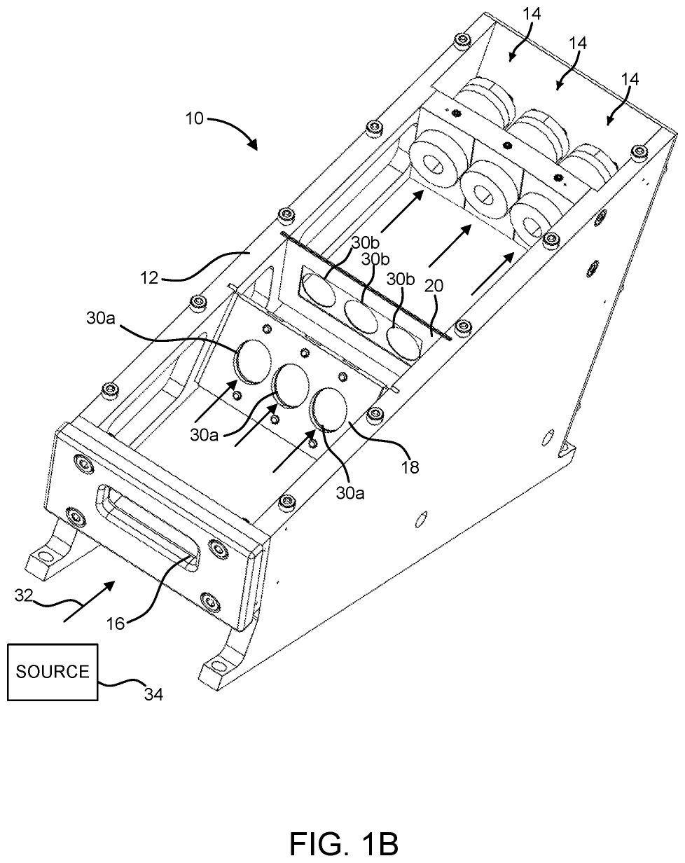

Referring to FIGS. 1A and 1B, a test mount assembly 10 is illustrated. The test mount assembly 10 may include a test mount 12 that may secure one or more electromagnetic calorimeters 14 relative to a test mount aperture 16 and electromagnetic filter holders 18, 20.

One or both of the electromagnetic filter holders 18 and 20 may define openings 30a, 30b (e.g., circular openings) that are configured to receive electromagnetic radiation from the test mount aperture 16. Also, one or both of the electromagnetic filter holders 18 and 20 may include filter material that spans a corresponding opening the electromagnetic filter holders 18 and 20. For example, the electromagnetic filter holder 18 may include filter material that spans the respective openings 30a. The filter material may be a micron thick.

The electromagnetic filter holders 18 and 20 may be angled with respect to one another. For example, the openings 30a of the electromagnetic filter holder 18 may be configured to receive electromagnetic radiation from the test mount aperture 16 at a front end of the electromagnetic filter holder 18. The openings 30a may define respective central axes that extend from a back end of the electromagnetic filter holder 18 away from the front end into the test mount 12. Angling the electromagnetic filter holder 18 such that the central axes do not extend through corresponding apertures defined by the electromagnetic filter holder 20, may prevent blow off of filter material of a filter spanning the openings of the electromagnetic filter holder 18 from reaching and damaging the electromagnetic calorimeters 14.

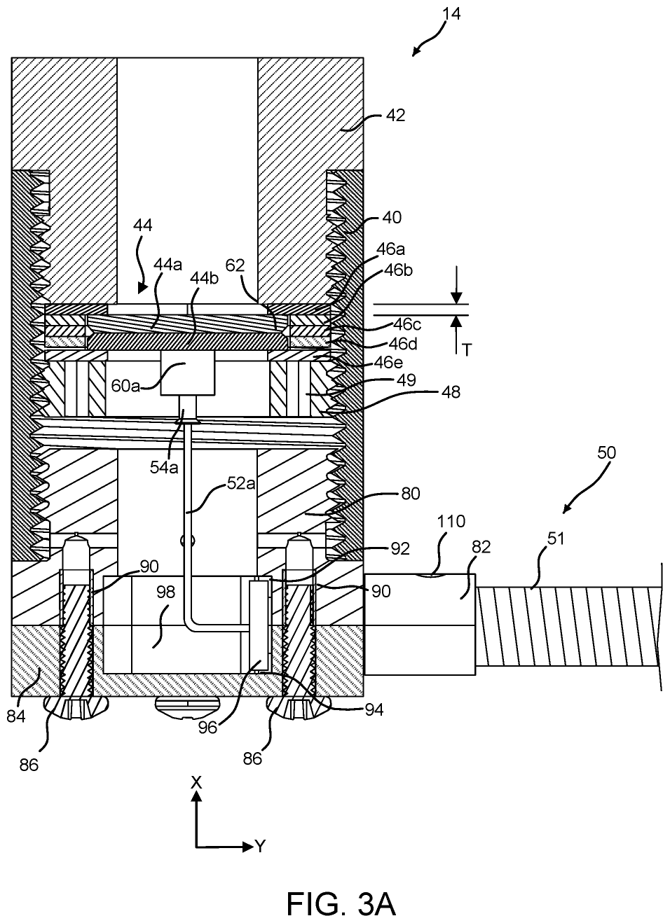

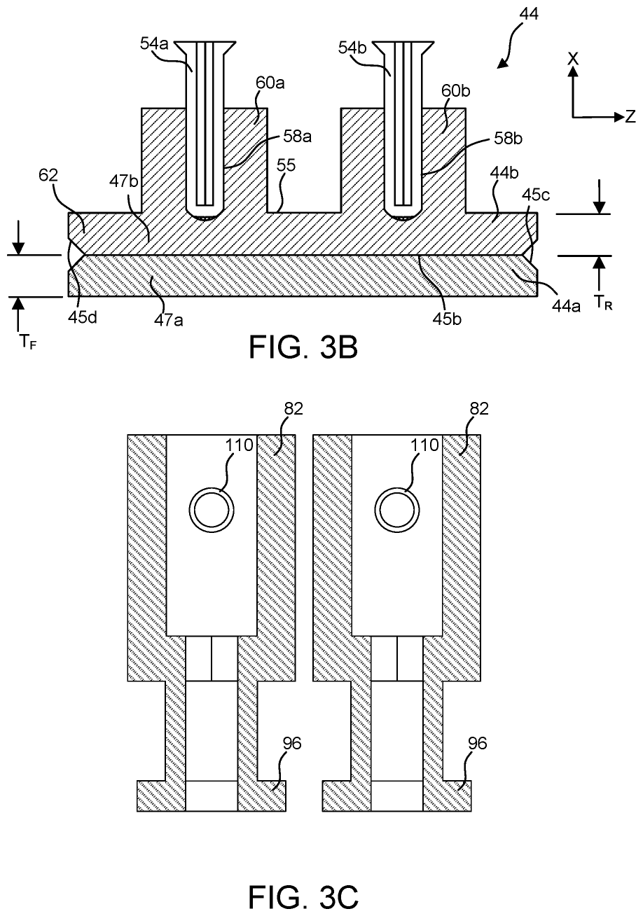

During use, a portion of electromagnetic radiation 32 (e.g., X-rays with a fluence of anywhere from 0.2-10.0 cal/cm²), represented by black arrows in FIG. 1B, travels along a pathway from a source 34 (e.g., an ampoule that generates X-rays upon being impinged with a laser beam) to the electromagnetic calorimeters 14. For example, the portion of electromagnetic radiation 32 may travel from the source 34 through the test mount aperture 16, then to the openings 30a, then to the openings 30b, and then to the electromagnetic calorimeters 14. The incident fluence may be limited by the filters to below that which will cause a front of an absorber 44 (discussed below with reference to FIGS. 3A-5) to vaporize. The filters may thus be configured based on the spectrum of the radiation and a material of the front of the absorber 44.

In an embodiment, two or less electromagnetic calorimeters receive a corresponding portion of the electromagnetic radiation. In another embodiment, more than three electromagnetic calorimeters receive a corresponding portion of the electromagnetic radiation.

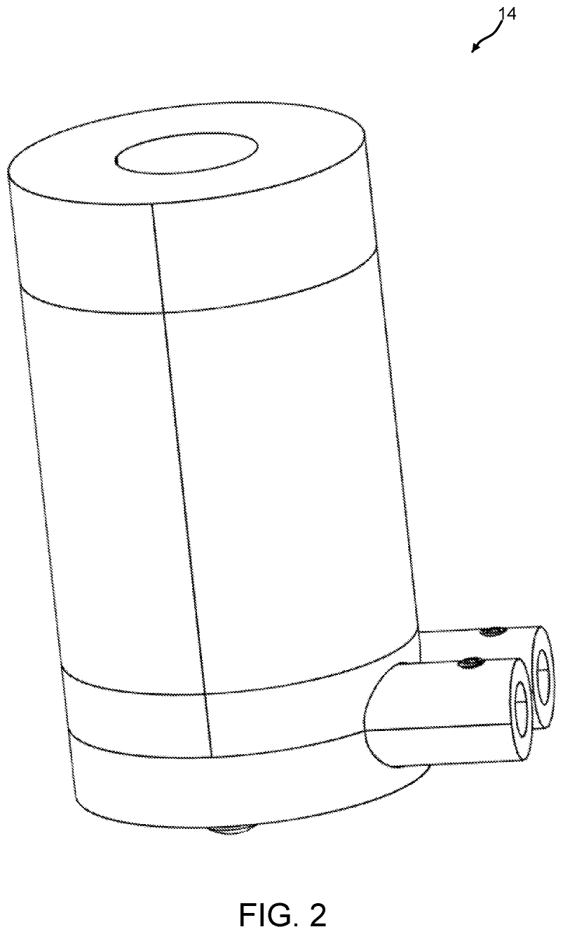

Turning to FIG. 2, one of electromagnetic calorimeters 14 is illustrated. In an embodiment, all of the electromagnetic calorimeters 14 are identical.

Referring now to FIGS. 3A-5, the electromagnetic calorimeter 14 may include a housing 40, an aperture body 42, the absorber 44 (an example of an electromagnetic calorimeter absorber), and cloth thermal insulators 46a-46e that are configured to secure the absorber 44. For example, the electromagnetic calorimeter 14 may include a retaining ring 48 (an example of a retainer body) that is configured to sandwich the absorber 44 and the cloth thermal insulators 46a-46e with the aperture body 42.

The cloth thermal insulators 46a-46e may be configured to thermally and electrically isolate the absorber 44 from the housing 40, the aperture body 42, and the retaining ring 48.

The absorber 44 may include a front portion 44a and a rear portion 44b. The front portion 44a may comprise a first material, and a rear portion may comprise a second material that is different from the second material. For example, the second material may have a higher atomic number than the first material.

The first material may have a higher resistance to blow off than the second material. For example, the first material may have a high enthalpy to incipient vaporization (e.g., 2000 cal/g) relative to that of the second material. The first material may have a porosity that attenuates shock and provides better resistance to shock than the first material. For example, a solid density to distended density ratio of the first material may be about 1.2. Thus, while the first material (e.g., graphite with a spall strength of 0.5 kilobar (kbar)) may have a lower spall-strength than the second material (e.g., aluminum with a spall-strength of 10 kbar), the high enthalpy to incipient vaporization and/or the porosity of the first material may limit stress on the first material during a test event such that the first material has a higher resistance to blow off.

The rear portion 44b may be configured such when the electromagnetic radiation 32 is directed to the front portion 44a, more of the electromagnetic radiation is absorbed by the rear portion 44b than is absorbed by the front portion 44a. For example, the rear portion 44b may be configured such that when the electromagnetic radiation 32 has an energy of 5 KeV or more, more of the electromagnetic radiation 32 is absorbed by the rear portion 44b than is absorbed by the front portion 44a. In an embodiment, the when the electromagnetic radiation 32 has an energy of 8 KeV or more (e.g., 8 KeV to 13 KeV or 8 KeV to 11.5 KeV), more of the electromagnetic radiation 32 is absorbed by the rear portion 44b than is absorbed by the front portion 44a

The front portion 44a and the rear portion 44b together may be configured to absorb 99% or more of the electromagnetic radiation 32 that has an energy of 5 KeV or more. In some embodiments, the front portion and the rear portion together are configured to absorb 99% or more of the electromagnetic radiation 32 that has an energy of 8 KeV or more (e.g., 8 KeV to 13 KeV or 8 KeV to 11.5 KeV).

In some embodiments, the front portion and the rear portion together are configured to absorb 99% or more of the electromagnetic radiation that has an energy of 5 KeV to 13 KeV. For example, the front portion and the rear portion together may be configured to absorb 99% or more of the electromagnetic radiation that has an energy of 8 KeV to 11.5 KeV.

Referring particularly to FIG. 3B, the front portion 44a may define a rear surface 45a that faces a front surface 45b of the rear portion 44b. For example, a majority of the rear surface 45a of the front portion 44a may be in contact with the front surface 45b of the rear portion 44b. The rear surface 45a and the front surface 45b may each be a major surface of the respective front portion 44a and rear portion 44b.

The front portion 44a and the rear portion 44b may be colinear with one another. For example, a radially outermost extent of each of the front portion 44a and the rear portion 44b may be coextensive.

A cross-sectional area of the rear surface 45a of the front portion 44a may be identical to a cross-sectional area of the front surface 45b of the rear portion 44b. The rear surface 45a and the front surface 45b may be coextensive such that an entirety of the rear surface 45a of the front portion 44a may be in contact with the front surface 45b.

For example, the rear surface 45a of the front portion 44a may be planar, and the front surface 45b of the rear portion 44b may be planar. For example, the front portion 44a may include a front main body 47a, which may be disk shaped. The rear portion 44b may comprise a rear main body 47b, which may be disk shaped.

The contact between the front portion 44a and the rear portion 44b may provide for heat transfer from the front portion 44a to the rear portion 44b such that the heat absorbed by the front portion is detectable by the thermal sensor.

Each of the rear surface 45a and the front surface 45b may comprise 90% or more of the total cross-sectional area of the respective front portion or rear portion. A rear end of the front main body 47a may define both the rear surface 45a and a radially outer chamfer 45c that extends from a radially outer end of the front main body 47a to the rear surface 45a. A front end of the rear main body 47b may define both the front surface 45b and a radially outer chamfer 45d that extends from a radially outer end of the rear main body 47b to the front surface 45b.

Thus, the front portion 44a and the rear portion 44b may include respective chamfered surfaces 45c, 45d that extend from respective radially outer ends of the front portion 44a and the rear portion 44b to the respective rear surface 45a or front surface 45b. In an embodiment, the chamfers are not provided. For example, the rear surface 45a may extend to a radially outermost extent of the front portion 44a, and the front surface 45b may extend to a radially outermost extent of the rear portion 44b.

The front portion 44a and the rear portion 44b may be permanently attached to one another. For example, the rear surface 45a of the front portion 44a may be bonded to the front surface 45b of the rear portion 44b. A first epoxy (e.g., a low outgassing thermally conductive epoxy) may bond the rear surface 45a of the front portion 44a to the front surface 45b of the rear portion 44b. For example, the first epoxy may comprise EPO-TEK® 301 Epoxy, which is a low outgassing and thermally conductive epoxy, to bond the rear surface 45a of the front portion 44a to the front surface 45b of the rear portion 44b. The first epoxy may further comprise diamond particles (e.g., 0.75 micron sized diamond particles). For example, the first epoxy may comprise a mix of 0.75 micron sized diamond particles and the epoxy (e.g., in a mass ratio of 60% diamond dust to 40% EPO-TEK® 301 Epoxy).

The chamfered surfaces 45c, 45d may define a space (e.g., a V-shaped groove) therebetween that extends circumferentially around the rear surface 45a of the front portion 44a and the front surface 45b of the rear portion 44b. A second epoxy that outgasses less than the first epoxy that bonds the rear surface 45a and the front surface 45b together (e.g., a low vapor pressure epoxy, such as TORR SEAL® Low Vapor Pressure Epoxy) may be disposed in the space between the chamfered surfaces 45c, 45d. For example, the second epoxy may extend circumferentially around the entire rear surface 45a of the front portion 44a and the entire front surface 45b of the rear portion 44b. Thus, the second epoxy may form a ring around the entirety of the first epoxy.

The second epoxy may provide for reduced outgassing compared to the outgassing that would occur if the first epoxy bonds the rear surface 45a and the front surface 45b, without the second epoxy. For example, the second epoxy may prevent the first epoxy from outgassing. In an embodiment, the chamfered surfaces are not provided, and the second epoxy is provided around (e.g., circumferentially around) the first epoxy, thereby forming a ring of the second epoxy around the first epoxy and between the rear surface of the front portion and the front surface of the rear portion.

The attachment between the front portion 44a and the rear portion 44b may be such that there is no gap between the rear surface 45a and the front surface 45b. In an embodiment, the rear facing surface of the front portion may define a radially outermost end of the main body of the front portion, and the front facing surface of the rear portion may define a radially outermost end of the main body of the rear portion. In such embodiment, the entirety of the front facing surface and the entirety of the rear facing surface may be in direct contact with one another (e.g., bonded by an epoxy) such that no gap exists between the main body of the front portion and the main body of the rear portion.

A majority of front main body 47a of the front portion 44a may have a constant front thickness T_{F}. For example, a majority of the front main body 47a may have a front thickness T_{F} of anywhere from 0.746 mm (0.029 in) to 1.254 mm (0.049 in), such as 1 mm (0.04 in). In an embodiment, the front thickness T_{F} is anywhere from 0.873 mm (0.034 in) to 1.13 mm (0.044 in).

A majority of the rear portion 44b may have a constant thickness. For example, a majority of a rear main body 47b of the rear portion 44b may have a rear thickness T_{R} of anywhere from 0.746 mm (0.029 in) to 1.254 mm (0.049 in), such as 1 mm (0.04 in). In an embodiment, the rear thickness T_{R} is anywhere from 0.873 mm (0.034 in) to 1.13 mm (0.044 in).

In an embodiment, the rear thickness T_{R} is equal to the front thickness T_{F}. In some embodiments, the rear thickness T_{R} is greater than the front thickness T_{F}. In other embodiments, the rear thickness T_{R} is greater than the front thickness T_{F}.

The rear portion 44b may comprise a metal. For example, the rear main body 47b may be entirely formed of the metal (e.g., aluminum, such as 6061-T6 aluminum). In an embodiment, the entire rear portion 44b is comprised of the metal (e.g., aluminum).

The front portion 44a may comprise a different material from the rear portion 44b. For example, the front portion 44a may comprise a non-metal (e.g., graphite, such as AXM-5Q graphite). In an embodiment, an entirety of the front portion 44a is comprised of the non-metal (e.g., graphite).

The aperture body 42 may define a through hole that receives the corresponding portion of the electromagnetic radiation 32 (shown in FIG. 1B). The through hole may be configured such that the portion of the electromagnetic radiation 32 impinges the absorber 44 (e.g., the front portion 44a). Impinging the absorber 44 with the portion of electromagnetic radiation 32 may heat the absorber 44, thereby increasing a temperature of the absorber 44. For example, the electromagnetic radiation 32 may have an energy of 5 KeV or more (e.g., 8 KeV to 13 KeV or 8 KeV to 11.5 KeV), and a majority of the electromagnetic radiation 32 that impinges the absorber 44 may be absorbed by the rear portion 44b.

The through hole of the aperture body 42 may define a cross-sectional area of 0.08 inches squared (in²) (0.5 cm²). In some embodiments, the cross-sectional area may be less than or greater than 0.08 in² (0.5 cm²). For example, the through hole may define a diameter anywhere from 0.2 in to 0.5 in. The through hole may define a diameter anywhere from 0.3 in to 0.4 in (e.g., 0.315 in). This through hole may define an aperture diameter that may allow for maximum exposure of the absorber 44 without exposing other components within the electromagnetic calorimeter 14. In other words, the aperture diameter illustrated in FIGS. 2 and 3 may be the maximum sized aperture diameter for the configuration of the electromagnetic calorimeter 14 illustrated in FIGS. 2 and 3A. In an embodiment, the absorber 44 may be larger and thus accommodate the aperture diameter being larger. Also, in an embodiment, the aperture diameter may be smaller than the aperture diameter illustrated in FIGS. 2 and 3A, thus limiting the amount of energy deposited onto the absorber at a lever below that of the aperture diameter illustrated in FIGS. 2 and 3A.

In an embodiment, the aperture body is at least partially disposed within the housing. For example, a portion of the aperture body may be entirely disposed within the housing. Another portion of the aperture body may be external to the housing.

The aperture body 42 may be made of graphite (e.g., AXM-5Q graphite). For example, an entirety of the aperture body 42 may be graphite. The graphite of the aperture body 42 may prevent spalling and vaporization of the aperture body 42 when the electromagnetic radiation impinges the aperture body 42. Spalling or vaporizing of any amount of material from the aperture body 42 can result in material depositing onto the absorber 44, and thus adversely affect temperature measurements of the absorber 44.

The retaining ring 48 and the aperture body 42 may be configured to attach to the housing 40. For example, the retaining ring 48 and the aperture body 42 may threadedly engage with a radially inwardly facing surface of the housing 40, such that the retaining ring 48 and the aperture body 42 are longitudinally fixed relative to the housing 40. Accordingly, the absorber 44 may be longitudinally fixed relative to the housing 40 when sandwiched longitudinally by the cloth thermal insulators 46a-46e and by the aperture body 42 and the retaining ring 48.

The retaining ring 48 may include one or more tool engagement portions 49. For example, each tool engagement portion 49 may define a respective cylindrical through hole that each extend along a longitudinal axis X. The through holes may be diametrically opposed to one another relative to the longitudinal axis X. Thus, the through holes may be spaced from one another along a lateral axis Y that is perpendicular to the longitudinal axis X.

In an embodiment, the retaining ring is at least partially disposed within the housing. For example, the retaining ring may be entirely disposed within the housing.

Referring particularly to FIG. 3A, the electromagnetic calorimeter 14 may include a thermal sensor 50 that is thermally coupled to the absorber 44. The thermal sensor 50 may include two thermocouples 52a (one of which is shown in FIG. 3A) which may each extend through a respective flexible cable 51 (e.g., an armored flex cable).

The cloth thermal insulators 46a-46e may be configured to thermally and electrically isolate the absorber 44 from every other component of the electromagnetic calorimeter 14, except for the thermal sensor 50.

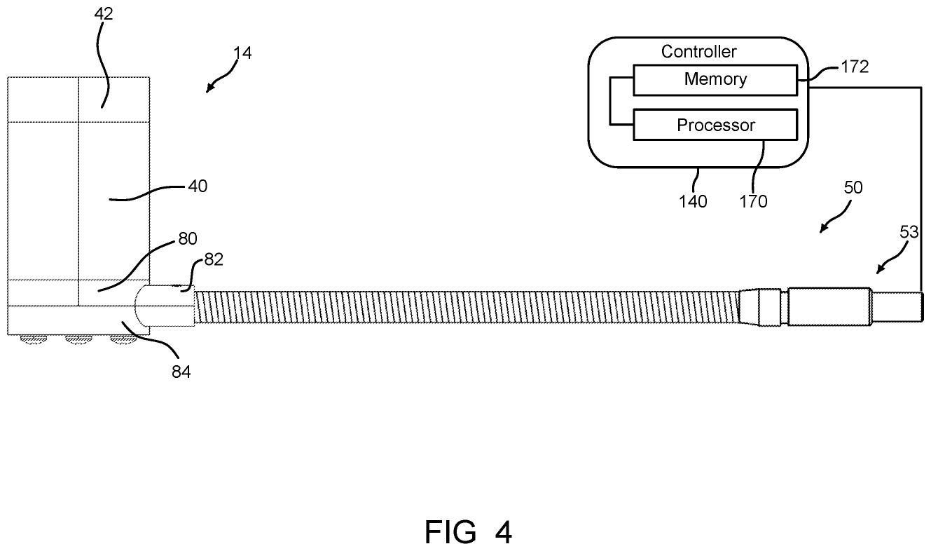

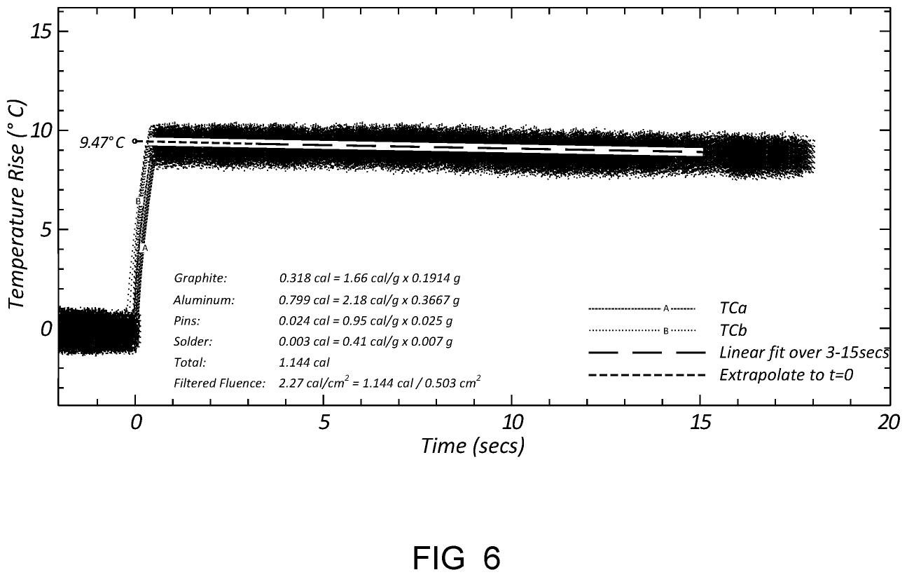

Referring also to FIG. 4, the thermal sensor 50 may include a connector 53 that receives one end of the thermocouples 52a. For example, the connector 53 may be configured to connect to a wiring harness (not shown) or terminal (not shown) to provide a voltage from the thermocouples 52a that is based on a change in temperature of the absorber 44 over time (see e.g., FIG. 6). The wiring harness or terminal may be configured to provide the voltage to a controller 140 (shown in FIG. 4, e.g., an oscilloscope) to provide the temperature of the absorber 44 over time (e.g., as shown in FIG. 6). As discussed above, the temperature of the absorber 44 may be based on the portion of electromagnetic radiation 32 that travels through the aperture body 42 to the absorber 44.

For example, another end of the thermocouples 52a may each be coupled to the absorber 44. Each thermocouple 52a may terminate in a respective solder cup 54a, 54b that is press fit a respective recess 58a, 58b of the absorber 44 (see e.g., FIG. 3B). The recesses 58a, 58b may each be formed in a respective protrusion 60a, 60b of the absorber 44.

Referring now to FIG. 3B, for example, the rear portion 44b may include one or more protrusions 60a, 60b that extend rearwardly from a rear surface 55 of the rear main body 44b away from the front portion 44a along the longitudinal axis X. The one or more protrusions may each be configured to receive a respective solder cup 54a, 54b.

Each thermocouple 52a may be soldered to the interior of the respective solder cup 54a, 54b. The mass of the solder may be kept to a minimum for each solder cup 54a, 54b.

A determined amount of electromagnetic energy may be based on a total thermal mass MT of the absorber 44 (e.g., the thermal mass of the front portion 44a, the rear portion 44b, and any bonding material attaching the two together, if any), the solder cups 54a, 54b, and the solder. The total thermal mass MT is based on the mass of each of the absorber 44, the solder cups 54a, 54b, and the solder. Accordingly, the mass of each of the absorber 44, the solder cups 54a, 54b, and the solder may be measured and/or determined prior to determining the amount of electromagnetic energy. In an embodiment, the mass of each of the absorber 44 and the solder cups 54a, 54b is measured prior to soldering, and the mass of the combination of the absorber 44, the solder cups 54a, 54b, and the solder is measured after soldering, and the total thermal mass MT is determined based on the mass measurements. Calculations based on such masses are discussed further below with reference to FIG. 6.

Each thermocouple 52a may comprise two conductive wires (e.g., a positive wire and a negative wire, not shown). For example, the thermocouples 52a may be type E.

The thermocouples 52a may provide for determining a quality of an electrical connection and a thermal connection between the thermocouples 52a and the absorber 44 (e.g., the rear portion 44b). For example, electrical resistance across the absorber 44 between the ends of the thermocouples 52a that is coupled to the absorber 44 may be measured and compared to a predetermined electrical resistance of the absorber 44 to determine the quality of the electrical connection and the thermal connection. The electrical resistance may be measured through the positive wires (not shown) of the thermocouples 52a.

The protrusions 60a, 60b may extend longitudinally along the longitudinal axis X such that the recesses 58a, 58b open along the longitudinal axis. For example, the protrusions 60a, 60b may be cylindrical and extend longitudinally away from a flange 62 that is defined by the front portion 44a and the rear portion 44b of the absorber 44.

Referring again to FIG. 3A, the flange 62 may be configured to be secured by the cloth thermal insulators 46a-46e. For example, the flange 62 may extend radially beyond the protrusions 60a, 60b from the longitudinal axis X such that the cloth thermal insulators 46a and 46e abut opposing longitudinally facing surfaces of the flange 62, thereby sandwiching the flange 62. Radially inwardly facing surfaces of the cloth thermal insulators 46b-46d may abut a radially outwardly facing surface of the flange 62.

Accordingly, the cloth thermal insulators 46a-46e may be disposed between the absorber 44 and the aperture body 42, between the absorber 44 and the housing 40, and/or between the absorber 44 and the retaining ring 48.

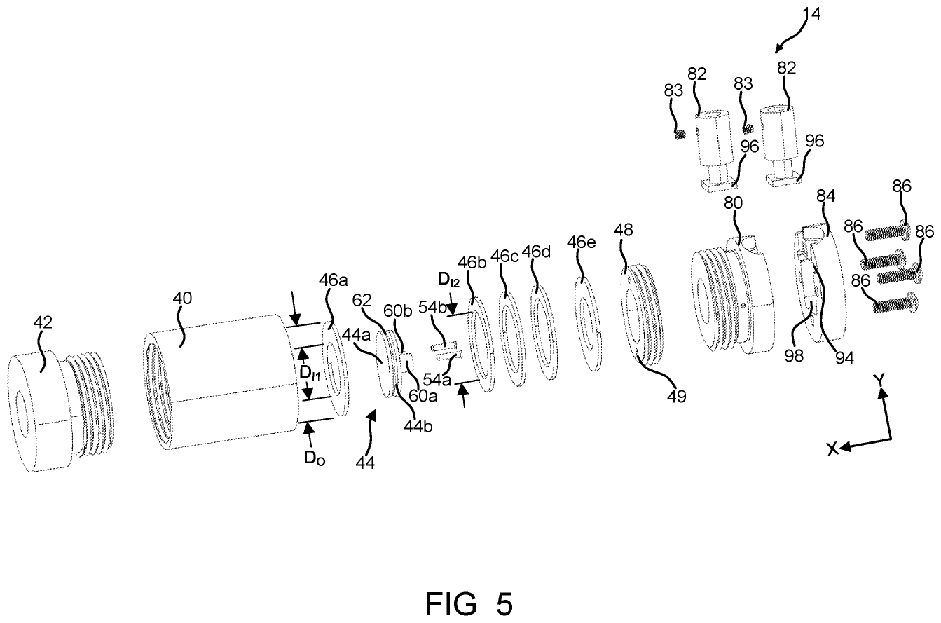

Referring now to FIGS. 3A and 5, cloth thermal insulators 46a-46e may define an outer diameter D_{O} of 0.64 in. In an embodiment, the outer diameter D_{O} is anywhere from 0.63 in to 0.65 in.

The cloth thermal insulators 46a, 46e may define an inner diameter D_{I2} of 0.36 in. In an embodiment, the inner diameter D_{I1} is anywhere from 0.35 in to 0.37 in.

The cloth thermal insulators 46b-46d may define an inner diameter D_{I2} that is greater than the inner diameter D_{I1} of the cloth thermal insulators 46a, 46e. For example, the inner diameter D_{I2} may be 0.46 in. In an embodiment, the inner diameter D_{I2} is anywhere from 0.45 in to 0.47 in.

The cloth thermal insulators 46a-46e may have a thickness T of 0.032 in along the longitudinal axis X. In an embodiment, the thickness T is anywhere from 0.02 in to 0.06 in.

In some embodiments, the cloth thermal insulators each have the same thickness. In other embodiments, at least one of the cloth thermal insulators has a different thickness from the other cloth thermal insulators.

The cloth thermal insulators 46a-46e may each be formed of a distinct ceramic cloth insulator (e.g., loose weave ceramic cloth, such as High-Temperature Ceramic Fiber Pipe Insulation, Alumina Oxide part number 87575K83 by McMaster-Carr®). For example, each of the cloth thermal insulators 46a-46e may be ring shaped with respective flat longitudinally facing surfaces and a cylindrical radially outwardly facing surface.

In an embodiment, three or less distinct cloth thermal insulators each abut the absorber. In another embodiment, five or more distinct cloth thermal insulators each abut the absorber.

The electromagnetic calorimeter 14 may include an end cap 80, a cable clamp 82, a retainer 84, and fasteners 86 that are configured to secure the retainer 84 to the end cap 80.

The end cap 80 may define a through hole such that the thermocouples 52a are extendable through the end cap 80 along the longitudinal axis X.

The end cap 80 may be configured to attach to the housing 40. For example, the end cap 80 may define a threaded portion that threadedly engage with the internal threads of the housing 40, such that the end cap 80 is longitudinal fixed relative to the housing 40.

The end cap 80 may include one or more fastener receiving openings. For example, the end cap 80 may include four threaded holes 90 (two are shown in FIG. 3A). The threaded holes 90 may be identical and equilaterally spaced about the longitudinal axis X. For example, the threaded holes 90 may be configured to threadedly engage with the fasteners 86 to secure the retainer 84 to the end cap 80.

The end cap 80 and the retainer 84 may define respective recesses 92, 94 that face one another along the longitudinal axis X to receive a corresponding portion of the cable clamp 82 (shown in further detail in FIG. 3C). For example, the recesses 92, 94 may receive a flange 96 of the cable clamp 82.

Thus, when the flange 96 of the cable clamp 82 is disposed in the recesses 92, 94 and the fasteners 86 are secured to the end cap 80, the cable clamp 82 may be fixed relative to the end cap 80 and the retainer 84.

The retainer 84 may define a sensor receiving groove 98 that extends from the recess 94, thereby providing space for the thermal sensor 50. For example, the thermocouple 52a may extend into the sensor receiving groove 98 from an opening of the cable clamp 82 that extends laterally along a lateral axis Y.

Each cable clamp 82 may be configured to clamp against an outer surface of the respective flexible cable 51. For example, each cable clamp 82 may define a through hole 110 (shown in FIG. 3C) that is configured to receive a fastener 83 that when in a locked position locks the flexible cable 51 in a through hole of the respective cable clamp 82. For example, each fastener 83 may be a threaded set screw that is configured to threadedly couple to internal threading of corresponding through hole 110, and when tightened each threaded set screw may abut against the outer surface of the respective flexible cable 51, thereby locking the respective flexible cable 51 relative to the corresponding cable clamp 82.

The housing 40, the end cap 80, the cable clamp 82, and the retainer 84 may be made of a metal. For example, each of the housing 40, the end cap 80, the cable clamp 82, and the retainer 84 may be made of aluminum. Each of the housing 40, the end cap 80, the cable clamp 82, and the retainer 84 may be entirely made of aluminum.

The retaining ring 48 may be made of a different material. For example, the retaining ring 48 may be made of a polymer, such as an acetal homopolymer (e.g., DELRIN® (e.g., white) from DUPONT®).

During assembly, the absorber 44, the cloth thermal insulators 46a-46e, and the solder cups 54a, 54b may be placed within the housing 40, along with the respective ends of the thermocouples 52a that are soldered to the solder cups 54a, 54b. The retaining ring 48 may be threadedly engaged with the internal threading of the housing 40 and rotated until the retaining ring 48 reaches a predetermined position at which the retaining ring 48 abuts the cloth thermal insulator 46e.

The aperture body 42 may be threadedly engaged with the internal threading of the housing 40 and rotated until the aperture body 42 reached a predetermined position at which the aperture body abuts the cloth thermal insulator 46a.

The end cap 80 may be threadedly engaged with the internal threading of the housing 40 and tightened until reaching a predetermined position relative to the housing 40. The cable clamp 82 may be positioned such that the flange 96 is disposed in the recess 92 of the end cap 80. The retainer 84 may be positioned such that the recess 94 receives the flange 96. The fasteners 86 may fix the end cap 80 and the retainer 84 to one another when the cable clamp 82 is positioned between the end cap 80 and the retainer 84, where the flange 96 is disposed in the recesses 92, 94.

The flexible cable 51 may be positioned within the cable clamp 82 such that locking of the fastener (not shown) of the cable clamp 82 fixes the cable clamp 82 and the flexible cable 51 together.

The connector 53 may be coupled to respective ends of the thermocouples 52a along with a respective end of the flexible cable 51, such that the flexible cable 51 and the respective ends of the thermocouples 52a are fixed to the connector 53.

At each step of assembly of the electromagnetic calorimeter 14, the mass of each component may be measured or determined.

Turning to FIG. 6, an example of expected temperature measurements of the absorber 44 taken by the thermal sensor 50 over time is illustrated, with light plot points “A” representing measurements from one of the thermocouples 52a, and dark plot points “B” representing measurements from another one of the thermocouples 52a. For example, during use, the portion of electromagnetic radiation 32 may travel through the aperture body 42 and impinge the absorber 44, thereby increasing the temperature of the absorber 44 (e.g., the rear portion 44b) based on the portion of electromagnetic radiation 32. The temperature of the absorber 44 (e.g., of the rear portion 44b) measured by each thermocouple 52a may increase by about 9.5° C. within less than half a second.

The portion of the electromagnetic radiation 32 may be absorbed by the front portion 44a and the rear portion 44b of the absorber. More of the portion of the electromagnetic radiation may be absorbed by the rear portion 44b than is absorbed by the front portion 44a. Heat due to the front portion 44a absorbing some of the portion of the electromagnetic radiation 32 may transfer directly from the rear surface 45a of the front portion 44a to the front surface 45b of the rear portion 44b, which may be detected by the thermal sensor 50.

A linear fit from 3 seconds to 18 seconds is represented with long dashes, and an extrapolation of the linear fit to 0 seconds (at 9.47° C.) is represented with short dashes.

With reference to FIGS. 3A, 3B, and 6, the front portion 44a of the absorber 44 may be entirely formed of 0.1914 grams (g) of graphite, with a specific heat of 1.66 calories (cal)/g, and thus a thermal mass (also referred to as a heat capacity) of 0.318 cal. The rear portion 44b of the absorber may be entirely formed 0.3667 g of aluminum, with a specific heat of 2.18 cal/g, and thus a thermal mass of 0.799 cal. Thus, the thermal mass of the entire absorber 44 may be 1.117 cal.

The solder cups 54a, 54b (also referred to as pins) may be formed of 0.025 g of gold or tin plated steel, with a specific heat of 0.215 cal/g, and thus a thermal mass of 0.024 cal. The solder may be formed of 0.007 g of silver solder, with a specific heat of 0.41 cal/g, and thus a thermal mass of 0.003 cal. Thus, the total thermal mass of the combination of the absorber 44, the solder cups 54a, 54b, and the solder may be 1.144 cal.

Accordingly, the filtered fluence may be 61.28 Joules (J)/in² (2.27 cal/centimeters-squared (cm²)), based on the total thermal mass of the combination 4.786 J (1.144 cal) divided by the area of the through hole/aperture of the aperture body 42 0.078 in² (0.503 cm²).

The same electromagnetic calorimeter 14 may be re-used for multiple independent tests to measure the electromagnetic energy received during a test event. For example, a single electromagnetic calorimeter 14 may be used to measure the electromagnetic energy of 12-15 different test events.

Referring again to FIG. 4, the controller 140 may include a processor 170 operatively connected to memory 172. The processor 170 may be configured to determine the linear fit and the extrapolation of the linear fit based on, for example, the temperature of the absorber 44 over time. The processor 170 may be configured to determine the total electromagnetic energy based on the temperature of the absorber 44 over time during a given test.

The controller 140 may be configured to send and/or receive signals to receive information from or direct operation of the one or more components of the electromagnetic calorimeter 14. For example, the controller 140 may be configured to receive data (e.g., voltage output) from the thermal sensor 50 (e.g., via a wiring harness or terminal). The controller 140 may be configured to store information received from the thermal sensor 50, for example, in the memory 172.

The controller 140 may include, or be operatively connected to, one or more electromagnetic calorimeters 14 (see e.g., FIG. 1B) and/or other sensors configured to detect and measure various other parameters of the electromagnetic radiation 32.

The processor 170 may be configured to connect with and communicate with the memory 172, which may be configured to receive and store the measured values. The memory 172 may include a random access memory (RAM) and/or a computer-readable storage medium, such as a read-only memory (ROM) or non-volatile RAM (NVRAM), for storing basic routines for starting and/or operating the processor 170, which may be configured as a controller, and/or another component of the electromagnetic calorimeter 14 and to transfer information between the various components and devices of the test mount assembly 10. The memory 172 may also store other software components necessary for the operation of the processor 170 and/or other components of the test mount assembly 10 including an operating system, software implementing a cleaning method as described herein, and/or the like. The processor 170 may include, or may be connected to, or otherwise in communication with, computer-readable storage media to store and retrieve information, such as program modules, data structures, or other data. It should be appreciated by those skilled in the art that computer-readable storage media may be any available media that provides for the storage of non-transitory data and that may be accessed by the processor 170. By way of non-limiting example, the computer-readable storage media may include volatile and non-volatile storage media, transitory computer-readable storage media, non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

The following are a number of nonlimiting EXAMPLES of aspects of the disclosure.

In one general aspect, calorimeter may include a housing. The calorimeter may also include an aperture body disposed within the housing and defining an aperture configured to allow electromagnetic radiation to move pass through a first end of the aperture body and out a second end of the aperture body along a first direction. The calorimeter may furthermore include an absorber disposed within the housing and configured to receive the electromagnetic radiation, where the absorber may include: a front portion formed of a first material that is configured to receive the electromagnetic radiation, and a rear portion formed of a second material that is further from the aperture body than the front portion along the first direction, and where the second material is different from the first material. Calorimeter may in addition include a thermal sensor thermally coupled to the absorber, such that the thermal sensor is configured to detect a change in temperature of the absorber. Other embodiments of this aspect include corresponding computer systems, apparatus, and computer programs recorded on one or more computer storage devices, each configured to perform the actions of the methods.

Implementations may include one or more of the following features. The calorimeter where the first material is more resistant to blow off or vaporization from the electromagnetic radiation than the second material. The calorimeter where the second material has a higher atomic number than the first material. The calorimeter where the rear portion is configured such when the electromagnetic radiation has an energy of 5 KeV or more, more of the electromagnetic radiation is absorbed by the rear portion. The calorimeter where the front portion and the rear portion together are configured to absorb 99% or more of the electromagnetic radiation that has an energy of 5 KeV or more. The calorimeter where a majority of a rear surface of the front portion is in contact with a front surface of the rear portion. The calorimeter where the front portion has a thickness of anywhere from 0.746 mm (0.029 in) to 1.254 mm (0.049 in), and a rear main body of the rear portion has a thickness anywhere from 0.746 mm (0.029 in) to 1.254 mm (0.049 in). The calorimeter where the second material may include a metal. The calorimeter where an entirety of the rear portion is formed of aluminum. The calorimeter where the first material may include a non-metal. The calorimeter where an entirety of the front portion is formed of graphite. The calorimeter where a majority of a rear surface of the front portion is in contact with a front surface of the rear portion. The calorimeter where a rear surface of the front portion is bonded to a front surface of the rear portion. The calorimeter may include a retainer body at least partially disposed within the housing and configured to limit movement of the absorber away from the aperture body, where the absorber is disposed between the aperture body and the retainer body. The calorimeter may include one or more cloth thermal insulators disposed between the absorber and the aperture body, between the absorber and the housing, and/or between the absorber and a retainer body. The calorimeter where the one or more cloth thermal insulators may include at least two first cloth thermal insulator plates that sandwich a radially outer portion of the absorber, and may include at least one second cloth thermal insulator plate that radially inwardly faces the radially outer portion of the absorber. Test mount assembly including a test mount and the calorimeter fixed by the test mount. A method may including directing electromagnetic radiation through the aperture defined by an aperture body to the front portion of the absorber; and receiving the electromagnetic radiation with the front portion of the absorber, thereby heating the absorber; and detecting, with the thermal sensor, a change in temperature of the absorber caused by the electromagnetic radiation. The method where detecting a change in temperature may include the thermal sensor detecting a change in temperature of the rear portion caused by the electromagnetic radiation. The method may include thermally insulating the absorber with one or more cloth thermal insulators. The method where the electromagnetic radiation may include X-rays and the calorimeter is an X-ray calorimeter. The method may include using the electromagnetic calorimeter absorber, using the electromagnetic calorimeter, or using the test mount assembly. The method may include directing electromagnetic radiation to the front portion of the absorber; receiving the electromagnetic radiation with the front portion of the absorber, thereby heating the absorber; and detecting, with a thermal sensor, a change in temperature of the absorber caused by the electromagnetic radiation. The method where detecting a change in temperature may include the thermal sensor detecting a change in temperature of the rear portion caused by the electromagnetic radiation. The method may include thermally insulating the absorber with one or more cloth thermal insulators. The method where the electromagnetic radiation may include X-rays and the electromagnetic calorimeter absorber is an X-ray calorimeter absorber. The calorimeter where the thermal sensor may include at least one thermocouple wire that is thermally coupled to the absorber. The calorimeter may include at least one solder cup that is attached to a respective one of the at least one thermocouple wire, where the at least one solder cup is configured to couple to the rear portion of the absorber, such that the at least one thermocouple wire is fixed to and thermally coupled to the absorber. The calorimeter where the at least one solder cup may include two solder cups, the at least one thermocouple wire may include two pairs of thermocouple wires, and each of the two solder cups is attached to respective ends of each respective pair of the two pairs of thermocouple wires. The calorimeter where the front portion and the rear portion are colinear and a cross-sectional area of the rear surface of the front portion is identical to a cross-sectional area of the front surface of the rear portion, such that an entirety of the rear surface of the front portion is in contact with the front surface. Implementations of the described techniques may include hardware, a method or process, or a computer tangible medium.

In one general aspect, electromagnetic calorimeter absorber may include a front portion that may include a first material. Electromagnetic calorimeter absorber may also include a rear portion that may include a second material. The electromagnetic calorimeter absorber may furthermore include where the first material is more resistant to blow off or vaporization from electromagnetic radiation than the second material. The electromagnetic calorimeter absorber may in addition include where the second material has a higher atomic number than the first material. Other embodiments of this aspect include corresponding computer systems, apparatus, and computer programs recorded on one or more computer storage devices, each configured to perform the actions of the methods.

Implementations may include one or more of the following features. The electromagnetic calorimeter absorber where the rear portion is configured such when the electromagnetic radiation is directed to the front portion, more of the electromagnetic radiation is absorbed by the rear portion. The electromagnetic calorimeter absorber where the rear portion is configured such when the electromagnetic radiation has an energy of 5 KeV or more, more of the electromagnetic radiation is absorbed by the rear portion. The electromagnetic calorimeter absorber where the front portion and the rear portion together are configured to absorb 99% or more of the electromagnetic radiation that has an energy of 5 KeV or more. The electromagnetic calorimeter absorber where the front portion and the rear portion together are configured to absorb 99% or more of the electromagnetic radiation that has an energy of 5 KeV to 13 KeV. The electromagnetic calorimeter absorber where the front portion and the rear portion together are configured to absorb 99% or more of the electromagnetic radiation that has an energy of 8 KeV to 11.5 KeV. The electromagnetic calorimeter absorber where a majority of a rear surface of the front portion is in contact with a front surface of the rear portion. The electromagnetic calorimeter absorber where the front portion and the rear portion are colinear and a cross-sectional area of the rear surface of the front portion is identical to a cross-sectional area of the front surface of the rear portion, such that an entirety of the rear surface of the front portion is in contact with the front surface. The electromagnetic calorimeter absorber where a rear surface of the front portion is bonded to a front surface of the rear portion. The electromagnetic calorimeter absorber where a low outgassing thermally conductive epoxy bonds the rear surface of the front portion to the front surface of the rear portion. The electromagnetic calorimeter absorber where a second epoxy that is configured to outgas less than the low outgassing thermally conductive epoxy forms a ring around the low outgassing thermally conductive epoxy. The electromagnetic calorimeter absorber where the front portion may include a front main body that is disk shaped. The electromagnetic calorimeter absorber where the rear portion may include a rear main body that is disk shaped. The electromagnetic calorimeter absorber where the rear portion may include one or more protrusions that extend rearwardly from a rear surface of the rear main body away from the front portion, where the one or more protrusions are each configured to receive a respective solder cup. The electromagnetic calorimeter absorber where a majority of the front portion has a constant thickness and a majority of the rear portion has a constant thickness. The electromagnetic calorimeter absorber where the front portion has a thickness of anywhere from 0.746 mm (0.029 in) to 1.254 mm (0.049 in), and a rear main body of the rear portion has a thickness anywhere from 0.746 mm (0.029 in) to 1.254 mm (0.049 in The electromagnetic calorimeter absorber where the front portion has a thickness of anywhere from 0.873 mm (0.034 in) to 1.13 mm (0.044 in), and the rear main body of the rear portion has a thickness anywhere from 0.873 mm (0.034 in) to 1.13 mm (0.044 in). The electromagnetic calorimeter absorber where the thickness of the front portion is equal to the thickness of the rear main body of the rear portion. The electromagnetic calorimeter absorber where the thickness of the front portion is 1 mm and the thickness of the rear main body of the rear portion is 1 mm. Electromagnetic calorimeter absorber to 43, where the electromagnetic radiation is X-ray radiation. The electromagnetic calorimeter absorber where the rear portion defines one or more protrusions that are each configured to receive a respective solder cup. The electromagnetic calorimeter absorber may include a solder cup disposed in a respective cavity of each of the one or more protrusions. The electromagnetic calorimeter absorber where the one or more protrusions are a pair of protrusions. The electromagnetic calorimeter absorber where the second material may include a metal. The electromagnetic calorimeter absorber where the second material may include aluminum. The electromagnetic calorimeter absorber where an entirety of the rear portion is formed of aluminum. The electromagnetic calorimeter absorber the first material may include a non-metal. The electromagnetic calorimeter absorber where the first material may include graphite. The electromagnetic calorimeter absorber where an entirety of the front portion is formed of graphite. Implementations of the described techniques may include hardware, a method or process, or a computer tangible medium.

It should be noted that the illustrations and descriptions of the examples shown in the figures are for exemplary purposes only, and should not be construed limiting the disclosure. One skilled in the art will appreciate that the present disclosure contemplates various examples. Additionally, it should be understood that the concepts described above with the above-described examples may be employed alone or in combination with any of the other examples described above. It should further be appreciated that the various alternative examples described above with respect to one illustrated example can apply to all examples as described herein, unless otherwise indicated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more examples or that one or more examples necessarily include these features, elements and/or steps. The terms “comprising,” “including,” “having,” and the like are synonymous and are used inclusively, in an open-ended fashion, and do not exclude additional elements, features, acts, operations, and so forth.

Although the disclosure has been described in detail, it should be understood that various changes, substitutions, and alterations can be made herein without departing from the spirit and scope of the present disclosure as defined by the appended claims. Additionally, any of the embodiments disclosed herein can incorporate features disclosed with respect to any of the other embodiments disclosed herein. Moreover, the scope of the present disclosure is not intended to be limited to the particular embodiments described in the specification. As one of ordinary skill in the art will readily appreciate from that processes, machines, manufacture, composition of matter, means, methods, or steps, presently existing or later to be developed that perform substantially the same function or achieve substantially the same result as the corresponding embodiments described herein may be utilized according to the present disclosure.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present application.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be understood that reference herein to “a” or “one” to describe a feature such as a component or step does not foreclose additional features or multiples of the feature. For instance, reference to a device having or defining “one” of a feature does not preclude the device from having or defining more than one of the feature, as long as the device has or defines at least one of the feature. Similarly, reference herein to “one of” a plurality of features does not foreclose the application from including two or more, up to all, of the features. For instance, reference to a device having or defining “one of a X and Y” does not foreclose the device from having both the X and Y.

1. A calorimeter comprising:
a housing;
an aperture body disposed within the housing and defining an aperture configured to allow electromagnetic radiation to move pass through a first end of the aperture body and out a second end of the aperture body along a first direction;
an absorber disposed within the housing and configured to receive the electromagnetic radiation, wherein the absorber comprises:
a front portion formed of a first material that is configured to receive the electromagnetic radiation, and
a rear portion formed of a second material that is further from the aperture body than the front portion along the first direction, and wherein the second material is different from the first material;
a thermal sensor thermally coupled to the absorber, such that the thermal sensor is configured to detect a change in temperature of the absorber.

2. The calorimeter of claim 1, wherein the first material is more resistant to blow off or vaporization from the electromagnetic radiation than the second material.

3. The calorimeter of claim 1, wherein the second material has a higher atomic number than the first material.

4. The calorimeter of claim 3, wherein the rear portion is configured such when the electromagnetic radiation has an energy of 5 KeV or more, more of the electromagnetic radiation is absorbed by the rear portion.

5-8. (canceled)

9. The calorimeter of claim 1, wherein the second material comprises a metal, and the first material comprises a non-metal.

10-16. (canceled)

17. The calorimeter of claim 1, further comprising one or more cloth thermal insulators comprises at least two first cloth thermal insulator plates that sandwich a radially outer portion of the absorber, and comprises at least one second cloth thermal insulator plate that radially inwardly faces the radially outer portion of the absorber.

18-20. (canceled)

21. A test mount assembly comprising:
a test mount; and
the calorimeter of claim 1 fixed by the test mount.

22. A method of operating the calorimeter of claim 1, the method comprising:
directing electromagnetic radiation through the aperture defined by an aperture body to the front portion of the absorber;
receiving the electromagnetic radiation with the front portion of the absorber, thereby heating the absorber; and
detecting, with the thermal sensor, a change in temperature of the absorber caused by the electromagnetic radiation.

23-25. (canceled)

26. An electromagnetic calorimeter absorber, comprising:
a front portion that comprises a first material; and
a rear portion that comprises a second material,
wherein the first material is more resistant to blow off or vaporization from electromagnetic radiation than the second material, and
wherein the second material has a higher atomic number than the first material.

27. The electromagnetic calorimeter absorber of claim 26, wherein the rear portion is configured such when the electromagnetic radiation is directed to the front portion, more of the electromagnetic radiation is absorbed by the rear portion.

28. (canceled)

29. The electromagnetic calorimeter absorber of claim 26, wherein the front portion and the rear portion together are configured to absorb 99% or more of the electromagnetic radiation that has an energy of 5 KeV or more.

30-31. (canceled)

32. The electromagnetic calorimeter absorber of claim 26, wherein a majority of a rear surface of the front portion is in contact with a front surface of the rear portion.

33. (canceled)

34. The electromagnetic calorimeter absorber of claim 26, wherein a rear surface of the front portion is bonded to a front surface of the rear portion.

35-36. (canceled)

37. The electromagnetic calorimeter absorber of claim 26, wherein the front portion comprises a front main body that is disk shaped, and the rear portion comprise a rear main body that is disk shaped.

38-40. (canceled)

41. The electromagnetic calorimeter absorber of claim 26, wherein the front portion has a thickness of anywhere from 0.746 mm (0.029 in) to 1.254 mm (0.049 in), and a rear main body of the rear portion has a thickness anywhere from 0.746 mm (0.029 in) to 1.254 mm (0.049 in).

42-46. (canceled)

47. The electromagnetic calorimeter absorber of claim 26, further comprising a solder cup disposed in a respective cavity of each of one or more protrusions of the rear portion.

48. (canceled)

49. The electromagnetic calorimeter absorber of claim 26, wherein the second material comprises a metal, and the first material comprises a non-metal.

50. The electromagnetic calorimeter absorber of claim 49, wherein the second material comprises aluminum, and the first material comprises graphite.

51-54. (canceled)

55. An electromagnetic calorimeter that comprises the electromagnetic calorimeter absorber of claim 26.

56. (canceled)

57. A method of using the electromagnetic calorimeter absorber of claim 26, the method comprising:
directing electromagnetic radiation to the front portion of the absorber;
receiving the electromagnetic radiation with the front portion of the absorber, thereby heating the absorber; and
detecting, with a thermal sensor, a change in temperature of the absorber caused by the electromagnetic radiation.

58-60. (canceled)
